(19) United States
(12) Patent Application Publication
(10) Pub. No.: US 2023/0080981 A1
(43) Pub. Date: Mar. 16, 2023

(54) PREDICTIVE MAINTENANCE EXPLANATIONS BASED ON USER PROFILE

(71) Applicant: International Business Machines Corporation, Armonk, NY (US)

(72) Inventors: Keith William Grueneberg, Stewart Manor, NY (US); Jonathan Tristan O'Gorman, Whitegate (IE); MUDHAKAR SRIVATSA, White Plains, NY (US); SUPRIYO CHAKRABORTY, White Plains, NY (US)

(21) Appl. No.: 17/447,449

(22) Filed: Sep. 13, 2021

(51) Int. Cl. G06Q 10/06; G06F 16/35; G06F 16/335; G06F 16/332

(52) U.S. Cl. CPC G06Q 10/063112; G06Q 10/063116; G06F 16/35; G06F 16/337; G06F 16/3329

(57) ABSTRACT

In an approach to predictive maintenance explanations based on a user profile, one or more computer processors receive a failure prediction associated with a physical asset of an organization. One or more computer processors receive a work order associated with the failure prediction and an assignment of a first user to the work order. One or more computer processors retrieve a profile associated with the first user. One or more computer processors determine a best match between a taxonomy node of a taxonomy of user expertise associated with the work order and the retrieved profile associated with the first user. Based on the determined best match, one or more computer processors generate an explanation of the failure prediction. One or more computer processors display the explanation to the first user.

### BACKGROUND OF THE INVENTION

The present invention relates generally to the field of machine learning, and more particularly to predictive maintenance explanations based on a user profile.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. Machine learning explores the study and construction of algorithms that can learn from and make predictions on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data.

Controlled Natural Language, and specifically, Controlled English, can be used to 1) express results of information extraction from free English text; 2) extend and adapt the information extraction process itself; and 3) enable a user to query the results, infer information relevant to their goals, and review the reasoning that led to conclusions. Controlled English enables the expression of information contained in text in a way that makes it readily accessible to a variety of users. The fundamental motivation for representing Natural Language Processing (NLP) in Controlled English is to allow a user, such as an analyst, that may not have the linguistic skills of a specialist (but does have a basic common sense understanding of language) to be more involved in the details of language processing.

Explaining results or recommendations of machine learning models can be a problem for organizations that implement predictive maintenance for physical assets associated with the organization. For clients and end users, it is important to not only understand that the predictive performance of a model is good, but to also understand why the model makes a prediction so that appropriate decisions can be made. For example, for a maintenance technician, the prediction can include an activity the technician may need to perform, and the technician has to trust the model enough to begin to take appropriate remedial action. Currently, predictive maintenance models tend to supply only accuracy or confidence interval values, while other solutions known in the art provide “why” explanations that are generic and not tailored for the user who needs to take the right action based on presented information.

### SUMMARY

A first aspect of the present invention disclose a computer-implemented method including one or more computer processors receiving a failure prediction associated with a physical asset of an organization. One or more computer processors receive a work order associated with the failure prediction and an assignment of a first user to the work order. One or more computer processors retrieve a profile associated with the first user. One or more computer processors determine a best match between a taxonomy node of a taxonomy of user expertise associated with the work order and the retrieved profile associated with the first user. Based on the determined best match, one or more computer processors generate an explanation of the failure prediction. One or more computer processors display the explanation to the first user. The present invention has the advantage of deriving an optimal explanation for a work order based on a predictive maintenance model by customizing the explanation to an assigned worker using a user profile of the worker.

A second aspect of the present invention discloses a computer program product including one or more computer readable storage media and program instructions collectively stored on the one or more computer readable storage media. The stored program instructions include program instructions to receive a failure prediction associated with a physical asset of an organization. The stored program instructions include program instructions to receive a work order associated with the failure prediction and an assignment of a first user to the work order. The stored program instructions include program instructions to retrieve a profile associated with the first user. The stored program instructions include program instructions to determine a best match between a taxonomy node of a taxonomy of user expertise associated with the work order and the retrieved profile associated with the first user. The stored program instructions include program instructions to generate an explanation of the failure prediction based on the determined best match. The stored program instructions include program instructions to display the explanation to the first user.

A third aspect of the present invention discloses a computer system including one or more computer processors and one or more computer readable storage media, where program instructions are collectively stored on the one or more computer readable storage media. The stored program instructions include program instructions to receive a failure prediction associated with a physical asset of an organization. The stored program instructions include program instructions to receive a work order associated with the failure prediction and an assignment of a first user to the work order. The stored program instructions include program instructions to retrieve a profile associated with the first user. The stored program instructions include program instructions to determine a best match between a taxonomy node of a taxonomy of user expertise associated with the work order and the retrieved profile associated with the first user. The stored program instructions include program instructions to generate an explanation of the failure prediction based on the determined best match. The stored program instructions include program instructions to display the explanation to the first user.

In another aspect, the present invention discloses a method including one or more computer processors storing a result, wherein the result includes at least one of the generated explanation, the matching taxonomy node, a determination of user satisfaction, and additional feedback from the user. An advantage of storing the result of the process is that as a corpus of explanations grows, the method, through machine learning, generates better quality explanations.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of an explanation program, on a server computer within the distributed data processing environment of FIG. 1, for predictive maintenance explanations based on a user profile, in accordance with an embodiment of the present invention; and

FIG. 3 depicts a block diagram of components of the server computer executing the explanation program within the distributed data processing environment of FIG. 1, in accordance with an embodiment of the present invention.

### DETAILED DESCRIPTION

Embodiments of the present invention recognize that efficiency may be gained by providing a solution for predictive maintenance models that generates an explanation of the predicted maintenance requirement that is targeted to the level of expertise, familiarity with an asset, education, certifications, etc. of a user. Embodiments of the present invention also recognize that improvements may be made to existing predictive maintenance models by supplementing work orders generated from predictive maintenance model outputs with information, i.e., the explanation, targeted for the technician tasked with resolving the problem. Implementation of embodiments of the invention may take a variety of forms, and exemplary implementation details are discussed subsequently with reference to the Figures.

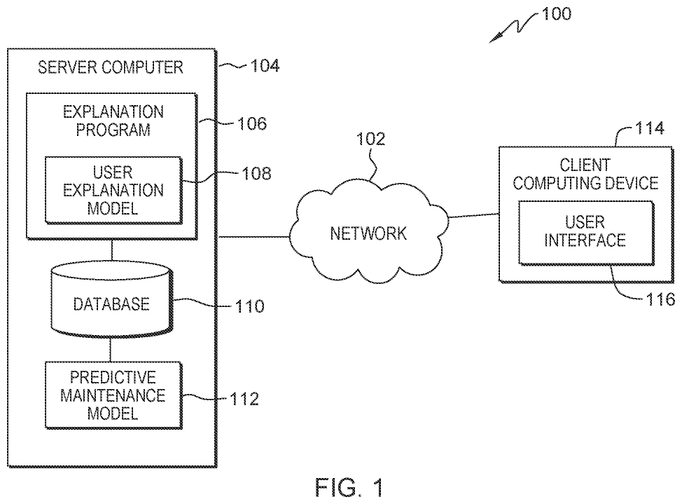

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 114, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 114, and other computing devices (not shown) within distributed data processing environment 100.

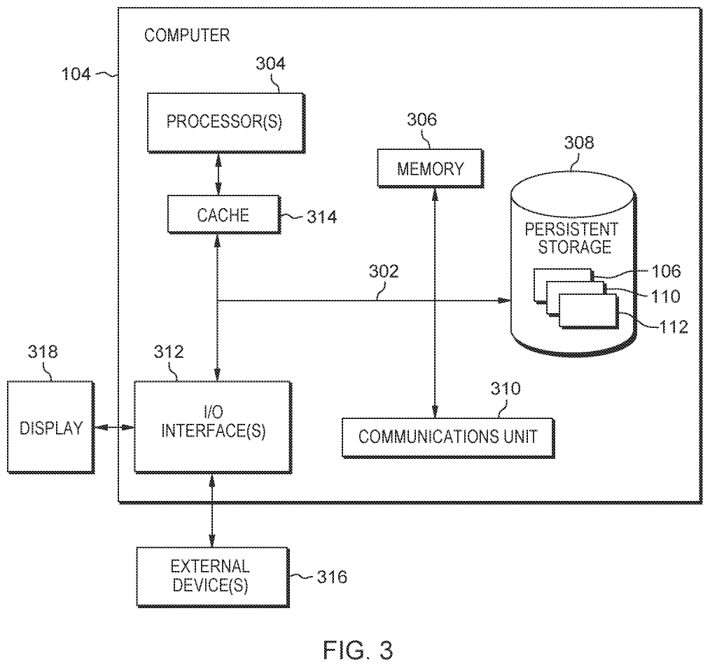

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 114, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes explanation program 106, database 110, and predictive maintenance model 112. Server computer 104 may include internal and external hardware components, as depicted and described in further detail with respect to FIG. 3.

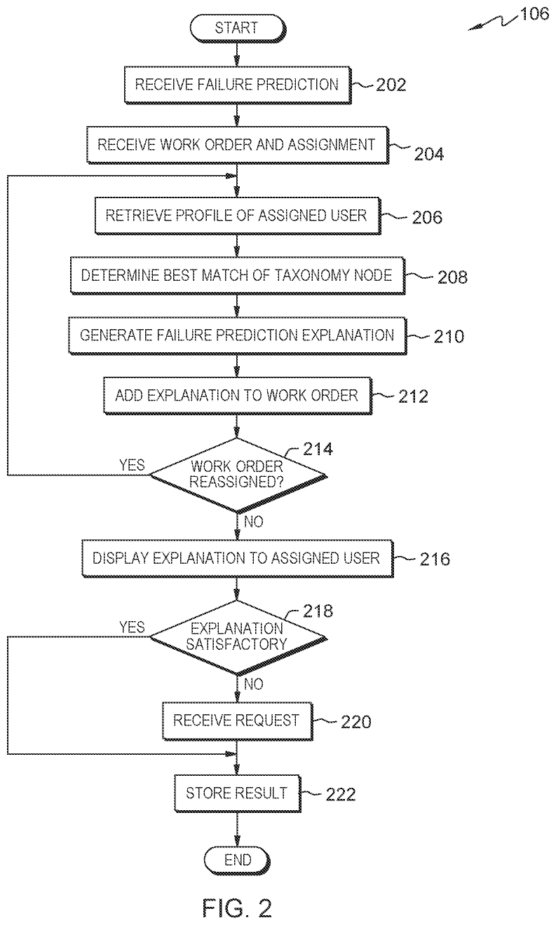

Explanation program 106 uses a profile of a maintenance technician, or other user, to derive an optimal explanation for a work order based on a finding by predictive maintenance model 112. Explanation program 106 receives a failure prediction, a work order, and an assignment of a user associated with the work order from predictive maintenance model 112. Explanation program 106 retrieves the profile of the assigned user. Explanation program 106 determines a best match of taxonomy node to the user profile. Explanation program 106 generates a failure prediction explanation and adds the generated explanation to the work order. Explanation program 106 displays the explanation to the user. Explanation program 106 determines if the explanation is satisfactory, and, if not, receives a request from the user. Based on the request, explanation program 106 generates a new explanation. Explanation program 106 stores the result of the explanation process in database 110. Explanation program 106 includes user explanation model 108. Explanation program 106 is depicted and described in further detail with respect to FIG. 2.

User explanation model 108 generates natural language explanations from a Controlled Natural Language (Controlled English) template for the failure predicted by predictive maintenance model 112 based on a node in a taxonomy of users and associated levels of expertise, skill, and/or experience that is the best match to the user assigned to the work order. Each node in the taxonomy represents a particular user expertise to which explanation program 106 matches the user when determining an explanation to display. In an embodiment, the templates may be generated from plain natural language by using an NLP parser that matches the natural language phrases to templates. For example, a template associated with node 1 may be described as: there is a ˜problem˜ A, while a template associated with node 2 may be described as: there is a ˜problem˜ A with ˜equipment name˜ B with ˜cause˜ C, and a template associated with node 3 may be described as: there is a ˜problem˜ A with ˜equipment name˜ B with ˜cause˜ C and ˜predicted failure˜ D, where the node numbers indicate an increasing level of expertise. In an embodiment, templates are pre-defined by a developer.

Database 110 stores information used and generated by explanation program 106. In the depicted embodiment, database 110 resides on server computer 104. In another embodiment, database 110 may reside elsewhere within distributed data processing environment 100, provided that explanation program 106 has access to database 110, via network 102. A database is an organized collection of data. Database 110 can be implemented with any type of storage device capable of storing data and configuration files that can be accessed and utilized by explanation program 106, such as a database server, a hard disk drive, or a flash memory. Database 110 represents one or more databases that store user profiles associated with each of the users that may be responsible for performing preventative maintenance on one or more assets. The user profiles may include a user's expertise with at least one of tools, assets (e.g., HVAC units), asset classes (e.g., all plumbing), asset brands, and the work site. The user profiles may also include, but are not limited to, an employer, a job title, a job role, a job family, a job level, a job seniority, a resume, professional certifications, qualifications and educational expertise, designated craft and skill level (e.g., an apprentice engineer vs. an engineer II vs. an engineer III), assets the user has historically worked on, locations where the user has historically worked, first time fix rate for a given asset or across asset classes, educational level, location of the user and/or of assets on which the user has worked, languages spoken by the user, time spent on work orders and on different types of work, and other characteristics as necessary to describe the user's expertise. Database 110 also stores a taxonomy of users and associated levels of expertise, skill, and/or experience created by explanation program 106. The taxonomy is comprised of one or more nodes, i.e., categories, with each taxonomy node representing a skill/experience level and/or role associated with a particular physical asset or type of work order activity/task. For example, one node in the taxonomy may represent an entry level technician, while another node in the taxonomy may represent an experienced engineer. Each of the users in the organization is matched with an equivalent node in the taxonomy based on information included in the user profiles. In addition, database 110 stores the results of the explanation process, including any feedback from the user, to enable machine learning over time. For example, explanation program 106 can adjust a profile of a user based on results of the explanation process such that matching the user to a node in the taxonomy becomes more accurate over time. The stored results form a corpus of explanations. Database 110 may also store one or more Controlled English templates defined by a developer for use with generating explanations.

The present invention may contain various accessible data sources, such as database 110, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Explanation program 106 enables the authorized and secure processing of personal data. Explanation program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Explanation program 106 provides information regarding personal data and the nature (e.g., type, scope, purpose, duration, etc.) of the processing. Explanation program 106 provides the user with copies of stored personal data. Explanation program 106 allows the correction or completion of incorrect or incomplete personal data. Explanation program 106 allows the immediate deletion of personal data.

Predictive maintenance model 112, as would be recognized by a person of skill in the art, is a system that predicts failures for given physical assets within an enterprise or organization and suggest preventative maintenance tasks to prevent failures of said physical assets. When predictive maintenance model 112 predicts a likely failure for a given asset, predictive maintenance model 112 generates a work order for the appropriate preventative action to be taken. In an embodiment, predictive maintenance model 112 assigns the work order to a technician, i.e., a user, automatically. In another embodiment, a planner, supervisor, or other responsible person in a related role assigns the work order to a user. In an embodiment, predictive maintenance model 112 makes the work order visible to one or more maintenance technicians, as well as one or more maintenance managers, reliability engineers, asset managers, and/or asset owners, and/or any individual that is part of the organization that owns the physical asset.

Client computing device 114 can be one or more of a laptop computer, a tablet computer, a smart phone, smart watch, a smart speaker, or any programmable electronic device capable of communicating with various components and devices within distributed data processing environment 100, via network 102. Client computing device 114 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch. In an embodiment, client computing device 114 may be integrated into a vehicle of the user. For example, client computing device 114 may include a heads-up display in the windshield of the vehicle. In general, client computing device 114 represents one or more programmable electronic devices or combination of programmable electronic devices capable of executing machine readable program instructions and communicating with other computing devices (not shown) within distributed data processing environment 100 via a network, such as network 102. Client computing device 114 includes an instance of user interface 116.

User interface 116 provides an interface between explanation program 106 and predictive maintenance model 112, on server computer 104, and a user of client computing device 114. In one embodiment, user interface 116 is mobile application software. Mobile application software, or an “app,” is a computer program designed to run on smart phones, tablet computers and other mobile devices. In one embodiment, user interface 116 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 116 enables a user of client computing device 114 to receive work orders and assignments from predictive maintenance model 112 and to receive explanations from explanation program 106. User interface 116 also enables a user of client computing device 114 to input user profile data for storage in database 110. In addition, user interface 116 enables a user to provide feedback to explanation program 106.

FIG. 2 is a flowchart depicting operational steps of explanation program 106, on server computer 104 within distributed data processing environment 100 of FIG. 1, for predictive maintenance explanations based on a user profile, in accordance with an embodiment of the present invention.

Explanation program 106 receives a failure prediction (step 202). In an embodiment, when predictive maintenance model 112 predicts a failure or other scenario that requires preventative maintenance of a physical asset, explanation program 106 receives the failure prediction. In one embodiment, predictive maintenance model 112 sends a notification that includes the failure prediction directly to explanation program 106. In another embodiment, when predictive maintenance model 112 sends a notification of a failure prediction to the user of client computing device 114, via user interface 116, explanation program 106 also receives the notification. In an embodiment, predictive maintenance model 112 stores the failure prediction in database 110 and explanation program 106 retrieves the failure prediction from database 110.

Explanation program 106 receives a work order and an assignment to the work order (step 204). In an embodiment, when predictive maintenance model 112 creates a work order for the maintenance activity associated with the predicted failure and assigns a user to perform the maintenance activity, explanation program 106 receives the work order and the assignment to the work order. In one embodiment, predictive maintenance model 112 sends a notification directly to explanation program 106. In another embodiment, when predictive maintenance model 112 sends a notification of the work order and the assignment of the work order to the user of client computing device 114, via user interface 116, explanation program 106 also receives the notification. In an embodiment, predictive maintenance model 112 stores the work order and the assignment to the work order in database 110, and explanation program 106 retrieves the work order and the assignment to the work order from database 110. In an embodiment, predictive maintenance model 112 creates the work order and notifies a planner/supervisor of the work order. When the planner/supervisor assigns a user to perform the maintenance activity associated with the work order, both predictive maintenance model 112 and explanation program 106 receive the assignment of the work order.

Explanation program 106 retrieves a profile of the assigned user (step 206). In an embodiment, explanation program 106 retrieves a user profile associated with the user assigned to perform the maintenance activity from database 110. Explanation program 106 retrieves information from within the user profile to determine the level of expertise, skill, and/or experience of the user regarding the asset that requires preventative maintenance and the specific maintenance activity included in the work order. For example, if the maintenance activity requires skills associated with plumbing, then explanation program 106 determines whether the user was just recently certified to perform plumbing maintenance versus whether the user is qualified as a master plumber. The level of expertise of the user indicates the degree of technical content that explanation program 106 includes in the explanation of the failure prediction and why the maintenance activity is required.

Explanation program 106 determines a best match of taxonomy node (step 208). In an embodiment, explanation program 106 retrieves the taxonomy of user expertise associated with the physical asset and/or work order activity/task included in the work order from database 110 and compares the determined level of expertise of the assigned user to the taxonomy to determine an equivalent node of the taxonomy that matches the user. An advantage of retrieving the profile of the user, is that over time, the user becomes more experienced, and, therefore, the user profile changes. Thus, retrieving the profile each time a work order is assigned enables explanation program 106 to use the most recent expertise level of the user in a comparison with the taxonomy nodes.

Explanation program 106 generates a failure prediction explanation (step 210). In an embodiment, explanation program 106 generates an explanation of the failure prediction via user explanation model 108. As discussed previously, based on the determined best match between the taxonomy node and the user profile, user explanation model 108 generates a natural language explanation from a Controlled English template for the failure predicted by predictive maintenance model 112. For example, if the best matching node is for a user with minimal technical expertise, then user explanation model 108 generates an explanation in simple terms, such as “part X needs to be replaced because it will fail soon.” In another example, if the best matching node is for a user with an engineering background, then user explanation model 108 generates an explanation with more technical detail, such as “part X is expected to experience a fatigue failure in 500 cycles, and X should be replaced within the next 4 workdays.”

In an embodiment, user explanation model 108 generates failure prediction explanations that incorporate one or more explanation criteria. For example, a “contrastive” criteria explains why event P happened instead of event Q (e.g., why is a particular asset predicted to fail rather than a different asset?). In another example, a “selected” criteria explains one or two pertinent attributes of an asset that are predicted to fail, rather than a complete explanation, even if the explanation is more complex (e.g., the vibration and time since install date of the HVAC unit indicates a likely failure). In yet another example, an “abnormal” criteria highlights if one of the input features for a prediction was abnormal in any sense, even if normal features contributed to the prediction (e.g., the temperature of the centrifugal fan exceeded 50 degrees Celsius, indicating a failure).

Explanation program 106 adds the explanation to the work order (step 212). In an embodiment, explanation program 106 associates the text generated by user explanation model 108 with the work order created by predictive maintenance model 112 such that the work order includes both the maintenance activity to perform and the explanation of why that activity is required.

Explanation program 106 determines if the work order is reassigned (decision block 214). In an embodiment, explanation program 106 determines whether the assignment of the work order has been transferred to a second user, either by predictive maintenance model 112 or a by planner/supervisor. For example, if after predictive maintenance model 112 assigns the work order to a first user and the first user becomes unavailable, then predictive maintenance model 112 assigns the work order to a second user.

If explanation program 106 determines the work order is reassigned (“yes” branch, decision block 214), then explanation program 106 returns to step 206 and retrieves the profile of the newly assigned user. In an embodiment where a second user is assigned to a work order, explanation program 106 retrieves the profile of the second user from database 110 and proceeds to re-generate the failure prediction explanation based on another best match of a taxonomy node to the expertise of the second user.

If explanation program 106 determines the work order is not reassigned (“no” branch, decision block 214), then explanation program 106 displays the explanation to the assigned user (step 216). In an embodiment, explanation program 106 displays the failure prediction explanation to the user of client computing device 114 via user interface 116. In an embodiment, explanation program 106 displays the work order and the failure prediction explanation simultaneously. In another embodiment, explanation program 106 displays the work order and an interactive button that the user can click on via user interface 116 to display the explanation. Based on receiving an explanation, the user can have a better understanding of the underlying issue that was predicted and may infer from the explanation the appropriate course of action to maintain the asset.

Explanation program 106 determines if the explanation is satisfactory (decision block 218). In an embodiment, in addition to the work order and the failure prediction explanation tailored to the equivalent node of the assigned user, explanation program 106 displays additional options, via user interface 116, for the user to indicate whether the provided explanation is sufficient, i.e., whether the user is satisfied with the explanation. For example, explanation program 106 may display a question, such as “Is this explanation satisfactory?” or “Do you need more information?” with associated “yes” and “no” buttons for the user to select from. An advantage of determining user satisfaction with an explanation is that, based on the response, explanation program 106 can adjust the profile of the user using machine learning for better matching in the future.

If explanation program 106 determines the explanation is not satisfactory (“no” branch, decision block 218), then explanation program 106 receives a request (step 220). In an embodiment, explanation program 106 receives a request, via user interface 116, for a different explanation. For example, the user may request to view explanations from other nodes in the taxonomy, such as a more in-depth explanation for an engineer-type role, even if the user is at a lower expertise level. In another example, the user may request that the explanation incorporate one or more explanation criteria, such as a contrastive criteria. In an embodiment, in response to receiving a request for a different explanation, explanation program 106 returns to step 210 to generate a new failure prediction explanation.

If explanation program 106 determines the explanation is satisfactory (“yes” branch, decision block 218), then explanation program 106 stores the result (step 222). In an embodiment, explanation program 106 stores the generated explanation, the matched node, and the user response (i.e., satisfactory, not satisfactory, and/or any additional feedback) in database 110. An advantage of storing the result of the process is that as the corpus of explanations grows, explanation program 106, through machine learning, generates better quality explanations. In an embodiment, explanation program 106 updates the user profile of the user to include the additional experience gained by performing the maintenance activity.

In an example of the performance of explanation program 106, User 1 is a maintenance technician at a water facility and has been assigned a work order generated by predictive maintenance model 112 as a result of a predicted failure of a pump. User 1 is an unskilled worker who is typically assigned basic remedial tasks on a wide variety of assets at the facility. User 1 has little experience working with this type of pump. User 1 opens the work order and reviews the section explaining why predictive maintenance model 112 predicted the failure. The explanation, generated by user explanation model 108, reads “Too much noise at this pump means that it is likely to fail shortly from wear. The other pumps at this location are not noisy.” Before User 1 begins work on the pump, another work order is assigned to User 1 which takes priority. The work order on the pump is reassigned to User 2. User 2 is an engineer and is very familiar with these pumps, having worked on another pump, PUMP 1000, at this location. Following the reassignment, user explanation model 108 generates a new explanation based on the equivalent node in the taxonomy for the expertise of User 2, and explanation program 106 displays the explanation, which reads “Increased vibration at this pump has high correlation with decreased pumping efficiency flow through rates and reduced lift. In comparison, PUMP 1000 at this location is showing much higher fluid velocity and normal levels of vibration.” User explanation model 108 re-generated the explanation for User 2 in more precise language for an engineer to understand as well as taking into consideration the familiarity of User 2 with similar pumps.

FIG. 3 depicts a block diagram of components of server computer 104 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., explanation program 106, database 110, and predictive maintenance model 112, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 114. In these examples, communications unit 310 includes one or more network interface cards. Communications unit 310 may provide communications through the use of either or both physical and wireless communications links. Explanation program 106, database 110, predictive maintenance model 112, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., explanation program 106, database 110, and predictive maintenance model 112 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, a failure prediction associated with a physical asset of an organization;
receiving, by one or more computer processors, a work order associated with the failure prediction and an assignment of a first user to the work order;
retrieving, by one or more computer processors, a profile associated with the first user;
determining, by one or more computer processors, a best match between a taxonomy node of a taxonomy of user expertise associated with the work order and the retrieved profile associated with the first user;
based on the determined best match, generating, by one or more computer processors, an explanation of the failure prediction; and
displaying, by one or more computer processors, the explanation to the first user.

2. The computer-implemented method of claim 1, further comprising:
determining, by one or more computer processors, whether the explanation is satisfactory to the first user; and
responsive to determining the explanation is not satisfactory to the first user, receiving, by one or more computer processors, a request from the first user associated with the explanation.

3. The computer-implemented method of claim 2, wherein the request from the first user associated with the explanation is to view one or more explanations from one or more other taxonomy nodes.

4. The computer-implemented method of claim 1, further comprising:
determining, by one or more computer processors, the work order associated with the failure prediction is reassigned to a second user; and
retrieving, by one or more computer processors, a profile associated with the second user.

5. The computer-implemented method of claim 1, further comprising:
storing, by one or more computer processors, a result, wherein the result includes at least one of the generated explanation, a matching taxonomy node, a determination of user satisfaction, and additional feedback from the user.

6. The computer-implemented method of claim 1, further comprising:
adding, by one or more computer processors, the generated explanation to the work order.

7. The computer-implemented method of claim 1, wherein generating the explanation of the failure prediction further comprises:
generating, by one or more computer processors, a natural language explanation from a Controlled Natural Language template.

8. The computer-implemented method of claim 1, wherein the taxonomy node is associated with at least one of an expertise level, a skill level, and an experience level.

9. A computer program product comprising:
one or more computer readable storage media and program instructions collectively stored on the one or more computer readable storage media, the stored program instructions comprising:
program instructions to receive a failure prediction associated with a physical asset of an organization;
program instructions to receive a work order associated with the failure prediction and an assignment of a first user to the work order;
program instructions to retrieve a profile associated with the first user;
program instructions to determine a best match between a taxonomy node of a taxonomy of user expertise associated with the work order and the retrieved profile associated with the first user;
based on the determined best match, program instructions to generate an explanation of the failure prediction; and
program instructions to display the explanation to the first user.

10. The computer program product of claim 9, the stored program instructions further comprising:
program instructions to determine whether the explanation is satisfactory to the first user; and
responsive to determining the explanation is not satisfactory to the first user, program instructions to receive a request from the first user associated with the explanation.

11. The computer program product of claim 9, the stored program instructions further comprising:
program instructions to determine the work order associated with the failure prediction is reassigned to a second user; and
program instructions to retrieve a profile associated with the second user.

12. The computer program product of claim 9, the stored program instructions further comprising:
program instructions to store a result, wherein the result includes at least one of the generated explanation, a matching taxonomy node, a determination of user satisfaction, and additional feedback from the user.

13. The computer program product of claim 9, the stored program instructions further comprising:
program instructions add the generated explanation to the work order.

14. The computer program product of claim 9, wherein the program instructions to generate the explanation of the failure prediction comprise:
program instructions to generate a natural language explanation from a Controlled Natural Language template.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a failure prediction associated with a physical asset of an organization;
program instructions to receive a work order associated with the failure prediction and an assignment of a first user to the work order;
program instructions to retrieve a profile associated with the first user;
program instructions to determine a best match between a taxonomy node of a taxonomy of user expertise associated with the work order and the retrieved profile associated with the first user;
based on the determined best match, program instructions to generate an explanation of the failure prediction; and
program instructions to display the explanation to the first user.

16. The computer system of claim 15, the stored program instructions further comprising:
program instructions to determine whether the explanation is satisfactory to the first user; and
responsive to determining the explanation is not satisfactory to the first user, program instructions to receive a request from the first user associated with the explanation.

17. The computer system of claim 15, the stored program instructions further comprising:
program instructions to determine the work order associated with the failure prediction is reassigned to a second user; and
program instructions to retrieve a profile associated with the second user.

18. The computer system of claim 15, the stored program instructions further comprising:
program instructions to store a result, wherein the result includes at least one of the generated explanation, a matching taxonomy node, a determination of user satisfaction, and additional feedback from the user.

19. The computer system of claim 15, the stored program instructions further comprising:
program instructions add the generated explanation to the work order.

20. The computer system of claim 15, wherein the program instructions to generate the explanation of the failure prediction comprise:
program instructions to generate a natural language explanation from a Controlled Natural Language template.
